(19) United States
(12) Patent Application Publication
(10) Pub. No.: US 2011/0246076 A1
(43) Pub. Date: Oct. 6, 2011

(54) Method and System for Word Sequence Processing

(75) Inventors: Jian Su, Singapore (SG); Dan Shen, Saarbruecken (DE); Jie Zhang, Singapore (SG); Guo Dong Zhou, Singapore (SG)

(73) Assignee: AGENCY FOR SCIENCE, TECHNOLOGY AND RESEARCH

(21) Appl. No.: 11/597,801

(22) PCT Filed: May 28, 2005
(86) PCT No.: PCT/SG2005/000169

§ 371 Date: Jan. 28, 2008

(30) Foreign Application Priority Data
May 28, 2004 (SG) 200403036-7

(51) Int. Cl. G06F 19/00; G10L 11/00

(52) U.S. Cl. 702/19; 704/200

(57) ABSTRACT

A method and system of conducting named entity recognition. One method comprises selecting one or more examples for human labelling, each example comprising a word sequence containing a named entity and its context; and retraining a model for the named entity recognition based on the labelled examples as training data.

### FIELD OF INVENTION

The present invention relates broadly to methods and systems for word sequence processing, and in particular to a method and system for conducting named entity recognition, to a method and system for conducting a word sequence processing task, and to a data storage medium.

### BACKGROUND

Named entity (NE) recognition is a fundamental step to many complex natural language processing (NLP) tasks, such as Information Extraction. Currently, NE recognisers are developed using either rule-based approaches or supervised machine learning approaches. For the rule-based approaches, the rule set is required to be rebuild for each new domain or task. For supervised machine learning approaches a large annotated corpus such as MUC and GENIA are needed in order to achieve good performance. However, annotating a large corpus is difficult and time-consuming. In one group of supervised machine learning approaches, Support Vector Machines (SVM) are utilised.

On the other hand, active learning is based on the assumption that a small number of annotated examples and a large number of unannotated examples are available for a given domain or task. Different from supervised learning in which the entire corpus are labelled manually, active learning selects examples for labelling and adds the labelled example to a training set of a retrain model. This procedure is repeated until the model achieves a certain level of performance. Practically, a batch of examples are selected at a time, often referred to as batch-based sample selection, since it is time consuming to retrain the model if only one new example is added to the training set. Existing work in the area of batch-based sample selection focuses on two approaches, namely certainty-based methods and committee-based methods, to select the sample. While active learning has been explored in a number of less complex NLP tasks such as pattern of speech (POS) tagging, scenario event extraction, text classification, or statistical passing, active learning has not been explored or implemented for NE recognisers.

### SUMMARY

In accordance with a first aspect of the present invention, there is provided a method of conducting named entity recognition, the method comprising selecting one or more examples for human labelling, each example comprising a word sequence containing a named entity and its context; and retraining a model for the named entity recognition based on the labelled examples as training data.

The selecting may be based on one or more criteria of a group consisting of an informativeness criterion, a representativeness criterion, and a diversity criterion.

The selecting may further comprise applying a strategy comprising two or more of the criteria in a selected sequence.

The strategy may comprise combining two or more of the criteria into a single criteria.

In accordance with a second aspect of the present invention, there is provided a method of conducting a word sequence processing task, the method comprising selecting one or more examples for human labelling based on an informativeness criterion, a representativeness criterion, and a diversity criterion, and retraining a model for the named entity recognition based on the labelled examples as training data.

The word sequence processing task may comprise one or more of a group consisting of POS tagging, text chunking, parsing and word sense disambiguation.

In accordance with a third aspect of the present invention, there is provided a system for conducting named entity recognition, the system comprising a selector for selecting one or more examples for human labelling, each example comprising a word sequence containing a named entity and its context; and a processor for retraining a model for the named entity recognition based on the labelled examples as training data.

In accordance with a fourth aspect of the present invention, there is provided a system for conducting a word sequence processing task, the system comprising a selector for selecting one or more examples for human labelling based on an informativeness criterion, a representativeness criterion, and a diversity criterion, and a processor for retraining a model for the named entity recognition based on the labelled examples as training data.

In accordance with a fifth aspect of the present invention, there is provided a data storage medium having stored thereon computer code means for instructing a computer to execute a method of conducting named entity recognition, the method comprising selecting one or more examples for human labelling, each example comprising a word sequence containing a named entity and its context; and retraining a model for the named entity recognition based on the labelled examples as training data.

In accordance with a sixth aspect of the present invention, there is provided a data storage medium having stored thereon computer code means for instructing a computer to execute a method of conducting a word sequence processing task, the method comprising selecting one or more examples for human labelling based on an informativeness criterion, a representativeness criterion, and a diversity criterion, and retraining a model for the named entity recognition based on the labelled examples as training data.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a block diagram illustrating an overview of the process used in an embodiment of the present invention;

FIG. 2 is an example of a K-Means Clustering algorithm for clustering named entities, according to an example embodiment.

FIG. 3 shows an example of an algorithm used in selecting examples of machine-annotated named entities, according to an example embodiment.

FIG. 4 shows a first algorithm used in a Sample Selection Strategy for combining criteria, according to an example embodiment.

FIG. 5 shows a second algorithm used in a Sample Selection Strategy for combining criteria, according to an example embodiment.

FIG. 6 shows a plot of the effectiveness of the three informativeness-criterion-based selections according to example embodiments compared with a Random selection;

FIG. 7 shows a plot of the effectiveness of two multi-criteria-based selection strategies according to example embodiments compared with informativeness-criterion-based selection (Info_Min) according to an example embodiment and

FIG. 8 is a schematic diagram illustrating a NE recogniser according to an embodiment of the present invention.

### DETAILED DESCRIPTION

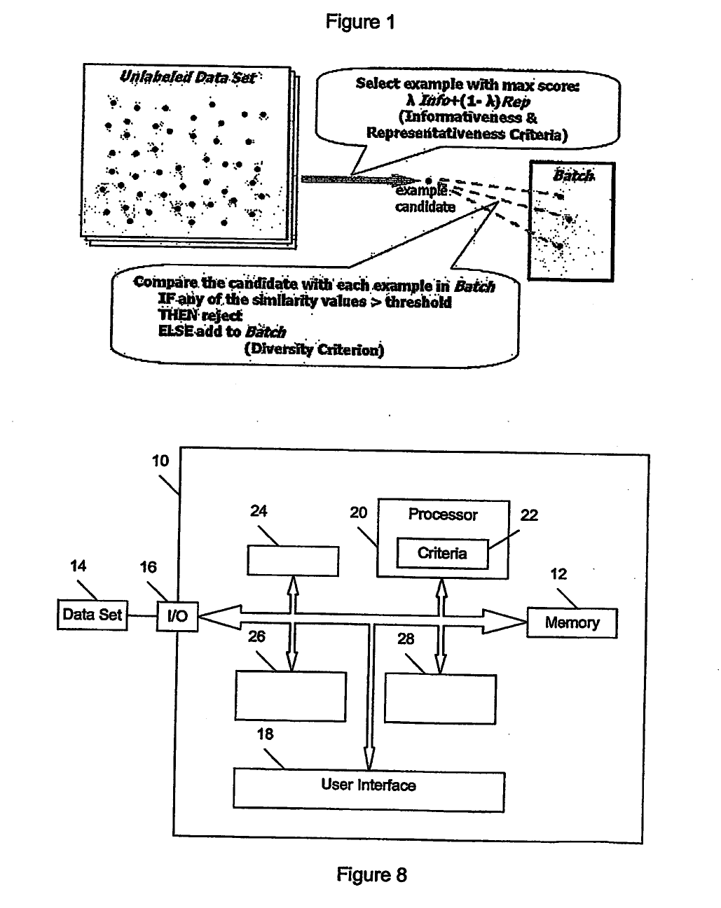

FIG. 1 shows a block diagram illustrating the process 100 used in an embodiment of the present invention. From an unlabeled data set 102, examples e.g. 103 are selected for a batch 104. The examples are selected based on informativeness and representativeness criteria. The selected examples are also judged against a diversity criteria with each example e.g. 106 already in the batch 104. If the newly selected example e.g. 103 is too similar to existing examples e.g. 106 the selected example 103 is rejected in the example embodiment.

Multi-criteria active learning named entity recognition in example embodiments reduces human annotation efforts. Multiple criteria: informativeness, representativeness and diversity are used to select most useful examples 103 in a named entity recognition task. Two selection strategies are proposed to incorporate these three criteria to increase the contribution of an example batch 104 towards improving the learning performance, which further reduces the batch size by 20% and 40%, respectively. Experimental results of the named entity recognition of embodiments of the present invention on both MUC-6 and GENIA show that the overall labelling cost can be largely reduced compared with supervised machine learning approaches, without degrading performance.

The described embodiments of the present invention further aim to reduce human annotation efforts in active learning for name entity recognition (NER), while still reaching the same level of performance as a supervised learning approach. For this purpose, these embodiments make a more comprehensive consideration on the contribution of individual examples, and seek to maximise the contribution of a batch based on three criteria: informativeness, representativeness and diversity.

In the example embodiments, there are three scoring functions to quantify the informativeness of an example, which can be used to select the most uncertain examples. The representativeness measure is used to choose the examples representing the majority. Two diversity considerations (global and local) avoid repetition among the examples of a batch. Finally, two combination strategies with the above three criteria reach an increased effectiveness on active learning for NER in different embodiments of the present invention.

### 1 Multi-Criteria for NER Active Learning

The use of Support Vector Machines (SVM) is a powerful machine learning method. In this embodiment, active learning methods are applied to a simple and effective SVM model to recognise one class of names at a time, such as protein names, person names, etc. In NER, SVM seeks to classify a word into positive class “1” indicating that the word is a part of an entity, or negative class “−1” indicating that the word is not a part of an entity. Each word in SVM is represented as a high-dimensional feature vector including surface word information, orthographic features, POS feature and semantic trigger features. The semantic trigger features include special head nouns for an entity class which is supplied by users. Furthermore, a window (size=7), which represents the local context of the target word w, is also used to classify w.

It has further been recognised that for active learning in NER, it is preferred to select a word sequence containing a named entity and its context, over selecting a single word as in typical SVMs. Even if a person is required to label a single word, he typically has to make an additional effort to refer to the context of the word. In the described active learning process in an example embodiment, a word sequence which consists of a machine-annotated named entity and its context is selected rather than a single word. It will be appreciated by a person skilled in the art that human annotated seed training set is used to provide the initial model for the machine-annotated named entities, the model being retrained with each additional selected batch of training examples. The measures used for active learning in example embodiments are applied to the machine-annotated named entities.

1.1 Informativeness

In the informativeness criterion a distance-based measure is used to evaluate the informativeness of a word and extend it to the measure of an entity using three scoring functions. Examples with a high informative degree are preferred, for which the current model is most uncertain.

1.1.1 Informativeness Measure for Word

In the simplest linear form, a training SVM finds a hyperplane that can separate the positive and negative examples in a training set with maximum margin. The margin is defined by the distance of the hyperplane to the nearest of the positive and negative examples. The training examples which are closest to the hyperplane are called support vectors. In SVM, only the support vectors are useful for the classification, which is different from statistical models. SVM training gets these support vectors and their weights from a training set by solving a quadratic programming problem. The support vectors can later be used to classify the test data.

The informativeness of an example in embodiments of the present invention is representative of the effect an example has on the support vectors when added to a training set. An example may be informative for the learner if the distance of its feature vector to the hyperplane is less than that of the support vectors to the hyperplane (equal to 1). Labelling an example that lies on or close to the hyperplane is typically guaranteed to have an effect on the solution. Thus, in this embodiment, the distance is used to measure the informativeness of an example.

The distance of an example's feature vector to the hyperplane is computed as follows:

$$Dist ( x ) = \vert {\sum }_{i = 1}^{N} {α}_{i} {y}_{i} K ( {s}_{i} , x ) + b \vert \qquad ( 1 )$$

where x is the feature vector of the example, αᵢ, yᵢ, sᵢ correspond to the weight, the class and the feature vector of the i^{th} support vector, respectively. N is the number of the support vectors in a current model.

The example with minimal Dist is selected, which indicates that it comes closest to the hyperplane in feature space. This example is considered most informative for the current model.

1.1.2 Informativeness Measure for Named Entity

Based on the above informativeness measure for a word, the overall informativeness degree of a named entity NE is computed based on a selected word sequence containing a named entity and its context. Three scoring functions are provided, as follows.

Let NE=w₁ . . . w_{N}, where N is the number of words in a selected word sequence.
Info_Avg: The informativeness of NE, Info (NE), is scored by the average distance of the words in the sequence to the hyperplane.

$$Info ( NE ) = \frac{N}{{\sum }_{{w}_{i} ∈ NE} Dist ( {w}_{i} )} \qquad ( 2 )$$

where, wᵢ is the feature vector of the i^{th} word in the word sequence.
Info_Min: The informativeness of NE is scored by the minimal distance of the words in the word sequence.

$$Info ( NE ) = \frac{1}{{Min}_{{w}_{i} ∈ NE} \{ Dist ( {w}_{i} ) \}} \qquad ( 3 )$$

Info_S/N: If the distance of a word to the hyperplane is less than a threshold a (=1 in the example embodiment task), the word is considered with short distance. Then, the proportion of the number of words with short distance to the total number of words in the word sequence is computed and this proportion is used to score the informativeness of the named entity.

$$Info ( NE ) = \frac{NUM ( {Dist}_{{w}_{i} ∈ NE} ( {w}_{i} ) < α )}{N} \qquad ( 4 )$$

The effectiveness of these scoring functions in example embodiments will be evaluated below. The informativeness measure used in example embodiments is relatively general and can be readily adapted to other tasks, in which the example selected is a sequence of words such as text chunking, POS tagging, etc.

1.2 Representativeness

In addition to the most informative example, the most representative example is also preferred in example embodiments. The representativeness of a given example can be evaluated based on how many examples there are similar to or near to the given example. Examples with a high representative degree are less likely to be an outlier. Adding a high representativeness example to the training set will have an effect on a large number of unlabeled examples. In this embodiment, the similarity between words is computed using a general vector-based measure, this measure is extended to the named entity level using a dynamic time warping algorithm and the representativeness of a named entity is quantified by the density of that NE. The representativeness measure used in this embodiment is relatively general and can be readily adapted to other tasks, in which the example selected is a sequence of words, such as text chunking, POS tagging, etc.

1.2.1 Similarity Measure Between Words

In a general vector space model, the similarity between two vectors may be measured by computing the cosine value of the angle between them. This measure, called cosine-similarity measure, has been used in information retrieval tasks to compute the similarity between two documents, or between a document and a query. The smaller the angle, the more similarity between the vectors. In the example embodiment task, the cosine-similarity measure is used to quantify the similarity between two words represented as high dimension feature vectors in SVM. Particularly, the calculation in SVM framework is written in terms of the kernel function as follows.

$$Sim ( {x}_{i} , {x}_{j} ) = \frac{\vert K ( {x}_{i} , {x}_{j} ) \vert}{\sqrt{K ( {x}_{i} , {x}_{i} ) K ( {x}_{j} , {x}_{j} )}} \qquad ( 5 )$$

where, xᵢ and xⱼ are the feature vectors of the words i and j.

1.2.2 Similarity Measure Between Named Entities

In this part, the similarity between two machine-annotated named entities is computed given the similarities between words. Regarding an entity as a word sequence, according to the example embodiments of the present invention, this computation is analogous to the alignment of two sequences. A dynamic time warping (DTW) algorithm (as described in L. R. Rabiner, A. E. Rosenberg and S. E. Levinson. 1978. Considerations in Dynamic Time Warping Algorithms for Discrete Word Recognition. In Proceedings of IEEE Transactions on acoustics, speech and signal processing. Vol. ASSP-26, No. 6.) is employed in the example embodiment to find an optimal alignment between the words in the sequences which maximises the accumulated similarity degree between the sequences. However, the algorithm is adapted as follows:

Let NE₁=w₁₁ w₁₂ . . . w₁ₙ . . . w_{1N}, (n=N) and NE₂=w₂₁ w₂₂ . . . w₂ₘ . . . w_{2M}, (m=1, . . . , M) denote two word sequences to be matched. NE₁ and NE₂ consist of N and M words, respectively. NE₁(n)=w₁ₙ and NE₂(m)=w₂ₘ. A similarity value Sim(w₁ₙ,w₂ₘ) is calculated using equation (5) for every pair of words (w₁ₙ,w₂ₘ) within NE₁ and NE₂. The goal of DTW is to find a path, m=map(n), which maps n onto the corresponding m, such that the accumulated similarity Sim* along the path is maximised.

$${Sim}^{*} = {Max}_{\{ map ( n ) \}} \{ {\sum }_{n = 1}^{N} Sim ( {NE}_{1} ( n ) , {NE}_{2} ( map ( n ) ) \} \qquad ( 6 )$$

The DTW algorithm is then used to determine the optimum path map(n). The accumulated similarity Sim_{A} to any grid point (n, m) can be recursively calculated as

$$\begin{matrix}{Sim}_{A} ( n , m ) = Sim ( {w}_{1 n} , {w}_{2 m} ) + {Max}_{q \leq m} {Sim}_{A} ( n - 1 , q ) \\ Finally , & ( 7 ) \\ {Sim}^{*} = {Sim}_{A} ( N , M ) & ( 8 )\end{matrix}$$

The overall similarity measure Sim* is normalised, as longer sequences normally give higher similarity values. Thus, the similarity between two sequences NE₁ and NE₂ is calculated as

$$Sim ( {NE}_{1} , {NE}_{2} ) = \frac{{Sim}^{*}}{Max ( N , M )} \qquad ( 9 )$$

1.2.3 Representativeness Measure for Named Entity

Given a set of machine-annotated named entities NESet={NE₁, . . . , NE_{N}}, the representativeness of a named entity NEᵢ in NESet is quantified by the density of NE; in the example embodiment. The density of NEᵢ is defined as the average similarity between NEᵢ and all the other entities NEⱼ in NESet as follows.

$$Density ( {NE}_{i} ) = \frac{{\sum }_{j \neq i} Sim ( {NE}_{i} , {NE}_{j} )}{N - 1} \qquad ( 10 )$$

If NEᵢ has the largest density among all the entities in NESet, it can be regarded as the centroid of NESet and also the most representative examples in NESet.

1.3 Diversity

The diversity criterion is used to maximise the training utility of a batch in the example embodiment. A batch in which the examples have high variance to each other is preferred. For example, given a batch size 5, it is preferable not to select five similar examples at a time. Two methods: local and global, are used in different embodiments to the examples in a batch. The diversity measure used in the example embodiments is relatively general and can be readily adapted to other tasks, in which the example selected is a sequence of words, such as text chunking, POS tagging, etc.

1.3.1 Global Consideration

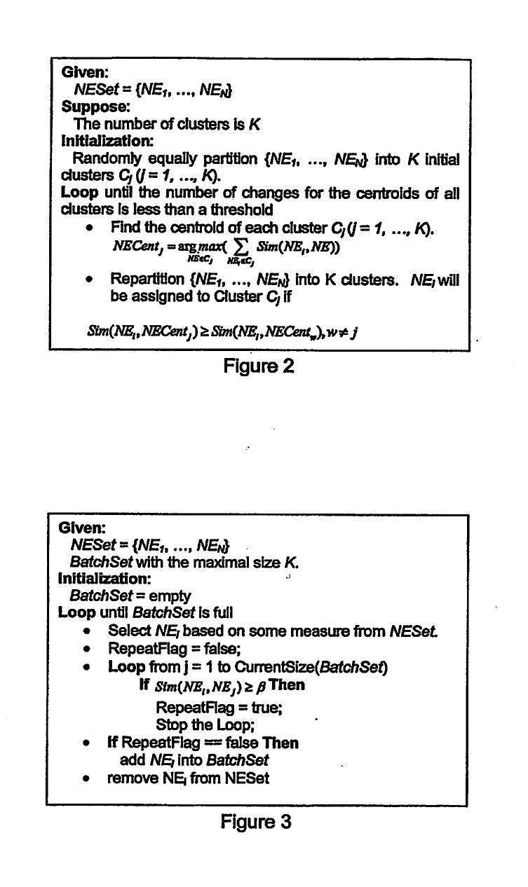

For a global consideration, all named entities in NESet are clustered based on the similarity measure proposed in (1.2.2) above. The named entities in the same cluster may be considered similar to each other, so named entities from different clusters are selected at one time. A K-means clustering algorithm, for example algorithm 200 as shown in FIG. 2, is used in the example embodiment. It will be appreciated that other clustering approaches may be used in different embodiments, including hierarchical clustering approaches, such as single-link cluster, complete-link clustering, group-average agglomerative clustering.

In each round of selecting a new batch of examples, the pair-wise similarities within each cluster are computed to get the centroid of the cluster. The similarities between each example and all centroids are also computed to repartition the examples. Based on the assumption that N examples are uniformly distributed between the K clusters, the time complexity of the algorithm is about O(N²/K+NK). In one of the experiments described below, the size of the NESet (N) is around 17000 and K is equal to 50, so the time complexity is about O(10⁶). For efficiency, the entities in NESet may be filtered before clustering them, which will be further discussed in Section 2 below.

1.3.2 Local Consideration

When selecting a machine-annotated named entity in example embodiments, the named entity is compared with all previously selected named entities in the current batch. If the similarity between them is above a threshold β, this example is not allowed to be added into the batch. The order of selecting examples is based on a measure such as an informativeness measure, a representativeness measure or a combination of those measures. An example local selection algorithm 300 is shown in FIG. 3. In this'way, it is possible to avoid selecting examples that are too similar (similarity value≧β) in a batch. The threshold β may be the average similarity between the examples in NESet.

This consideration only requires O(NK+K²) computational time. In one of the experiments (N≈17000 and K=50), the time complexity is about O(10⁵).

### 2 Sample Selection Strategies

This section describes how to combine and strike a balance between the criteria, viz. informativeness, representativeness and diversity, to reach a maximum effectiveness on NER active learning in example embodiments. The selection strategies are based on the varying priorities of the criteria and the varying degrees to satisfy the criteria.

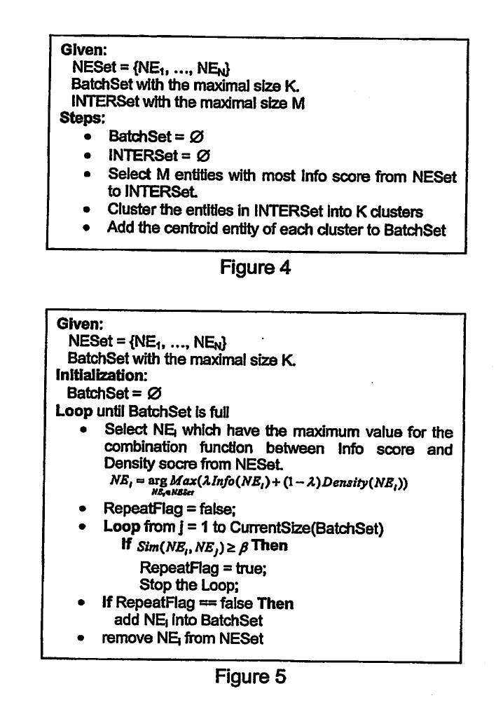

Strategy 1: First the informativeness criterion is considered. m examples are chosen with the highest informativeness scores from NESet for an intermediate set called INTERSet. By this pre-selecting, the selection process is made faster in later steps, since the size of INTERSet is much smaller than that of NESet. The examples in INTERSet are clustered and the centroid of each cluster is chosen and added into a batch called BatchSet. The centroid of a cluster is the most representative example in that cluster since it has the largest density. Furthermore, the examples in different clusters may be considered diverse to each other. In this strategy, representativeness and diversity criteria are considered at the same time. An example algorithm 400 for this strategy is shown in FIG. 4.

Strategy 2: The informativeness and representativeness criteria are combined using the function

λInfo(NEᵢ)+(1−λ)Density(NEᵢ), (11)

in which the Info and Density values of NEᵢ are normalised first. The individual importance of each criterion in this function (11) is adjusted by the trade-off parameter λ (0≦λ≦1) (set to 0.6 in the below experiment). First, a candidate example NEᵢ with the maximum value of this function from NESet is selected. Then, a diversity criterion using the local method described above in (2.3.2) is considered. The candidate example NEᵢ is added to a batch only if NEᵢ is different enough from any previously selected example in the batch. The threshold β is set to the average pair-wise similarity of the entities in NESet. An example algorithm 500 for strategy 2 is shown in FIG. 5.

### 3 Experimental Results and Analysis

3.1 Experiment Settings

In order to evaluate the effectiveness of the selection strategies in example embodiments, the strategies were applied to recognise protein (PRT) names in biomedical domains using GENIA corpus V1.1 (T. Ohta, Y. Tateisi, J. Kim, H. Mima and J. Tsujii. 2002. The GENIA corpus: An annotated research abstract corpus in molecular biology domain. In Proceedings of HLT 2002) and person (PER), location (LOC), organisation (ORG) names in newswire domain using MUC-6 corpus: Proceedings of the Sixth Message Understanding Conference, Morgan Kaufmann Publishers, San Francisco, Calif., 1995. First, the whole corpus was randomly split into three parts: an initial or seed training set to build an initial model, a test set to evaluate the performance of the model and an unlabeled set to select examples. The size of each data set is shown in Table 1.

TABLE 1
Experiment settings for active learning using
GENIA1.1 (PRT) and MUC-6 (PER, LOC, ORG)

| Domain | Class | Corpus | Initial Training Set | Test Set | Unlabeled Set |
|---|---|---|---|---|---|
| Biomedical | PRT | GENIA1.1 | 10 sent. (277 words) | 900 sent. (26K | 8004 sent. (223K |
| | | | | words) | words) |
| Newswire | PER | MUC-6 | 5 sent. (131 words) | 602 sent. (14K | 7809 sent. (157K |
| | | | | words) | words) |
| | LOC | | 5 sent. (130 words) | | 7809 sent. (157K |
| | | | | | words) |
| | ORG | | 5 sent. (113 words) | | 7809 sent. (157K |
| | | | | | words) |

Then, iteratively, a batch of examples was selected following the selection strategies proposed, human expert labelling of the examples of the batch, and adding the batch of examples into the training set. The batch size K=50 in GENIA and 10 in MUC-6. Each example was defined as a sequence of words containing a machine-recognised named entity and its context words (previous 3 words and next 3 words).

Some parameters in the experiments, such as the batch size K and the λ in the function (11) of strategy 2, may be decided based on experience. Preferably, however, the optimal value of these parameters should be decided automatically based on the training process.

The embodiments of the present invention seek to reduce the human annotation effort to learn a named entity recogniser with the same performance level as supervised learning. The performance of the models was evaluated using “precision/recall/F-measure”.

3.2 Overall Result in GENIA and MUC-6

The selection strategies 1 and 2 of the example embodiments were evaluated by comparison with a random selection method, in which a batch of examples was randomly selected iteratively, on GENIA and MUC-6 corpus. Table 2 shows the amount of training data needed to achieve the performance of supervised learning using the various selection methods, viz. Random, Strategy1 and Strategy2. The Info_Min scoring function (3) was used in Strategy1 and Strategy2.

TABLE 2
Overall Result in GENIA and MUC-6

| Class | Supervised | Random | Strategy1 | Strategy2 |
|---|---|---|---|---|
| PRT | 223K (F = 63.3) | 83K | 40K | 31K |
| PER | 157K (F = 90.4) | 11.5K | 4.2K | 3.5K |
| LOC | 157K (F = 73.5) | 13.6K | 3.5K | 2.1K |
| ORG | 157K (F = 86.0) | 20.2K | 9.5K | 7.8K |

In GENIA:
The model achieved 63.3 F-measure using 223K words in the supervised learning.
The best performer was Strategy2 (31K words), requiring less than 40% of the training data required Random (83K words), and 14% of the training data required by supervised learning to achieve 63.3 F-measure.
Strategy1 (40K words) performed slightly worse than Strategy2, requiring 9K more words.
Random (83K words) required about 37% of the training data required by supervised learning.

Furthermore, when the model was applied to newswire domain (MUC-6) to recognise person, location and organisation names, Strategy1 and Strategy2 showed an even better result in comparison to the supervised learning and Random, as shown in Table 2. On average, the training data required could be reduced by about 95% to achieve the same performance as the supervised learning in MUC-6.

3.3 Effectiveness of Different Informativeness-Based Selection Methods

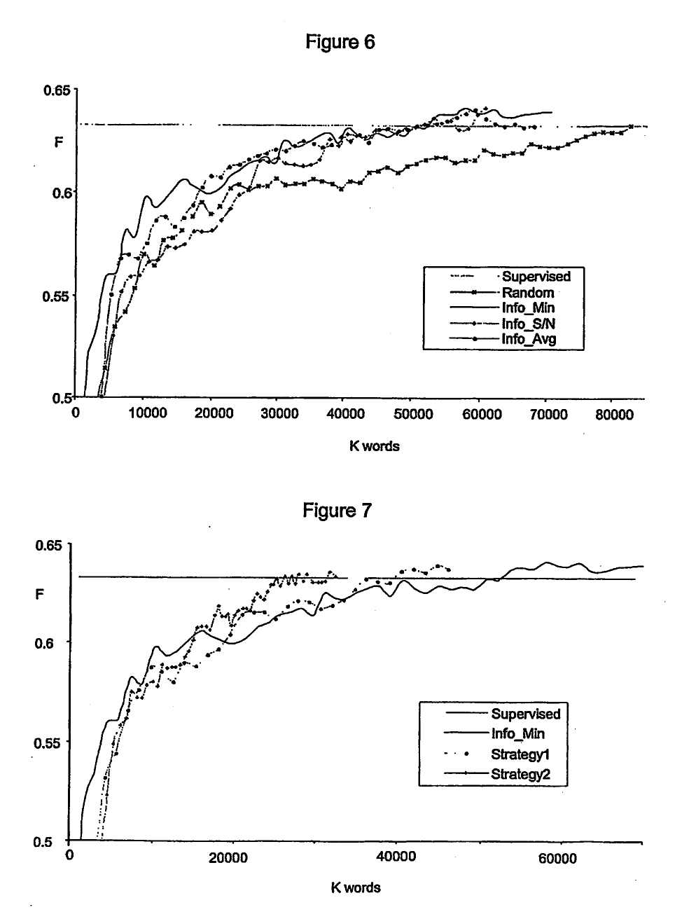

The effectiveness of the different informativeness scores (compare (1.1.2)) in NER task was also investigated. FIG. 6 shows plots of training data size versus F-measure achieved by the informativeness-based scores: Info_Avg(curve 600), Info_Min (curve 602) and Info_S/N (curve 604) as well as Random (curve 606). The comparisons were made in the GENIA corpus. In FIG. 6, the horizontal line is the performance level (63.3 F-measure) achieved by supervised learning (223K words). The three informativeness-based scores performed similarly and each outperformed Random. Table 3 highlights the various training data sizes required to achieve the 63.3 F-measure performance.

TABLE 3
Training data sizes for various selection methods to achieve
the same performance level as the supervised learning

| Supervised | Random | Info_Avg | Info_Min | Info_S/N |
|---|---|---|---|---|
| 223K | 83K | 52.0K | 51.9K | 52.3K |

3.4 Effectiveness of Strategies 1 And 2 Compared With Single Informativeness Criterion

In addition to the informativeness criterion, representativeness and diversity criteria are also incorporated into active learning in different embodiments using two strategies 1 and 2 described above (in Section 2). The comparison strategies 1 and 2 with the best result of the single-criterion-based selection methods using the Info_Min score illustrates that representativeness and diversity are also important factors for active learning. FIG. 7 shows the learning curves for the various methods: Strategy1 (curve 700), Strategy2 (curve 702) and Info_Min (curve 704). In the initial iterations (F-measure <60), the three methods performed similarly. But with the larger training set, the efficiencies of Strategy1 and Strategy2 begin to be evident. Table 4 summarises the result.

TABLE 4
Comparisons of training data sizes for the multi-criteria-based
selection strategies and the informativeness-criterion-based
selection (Info_Min) to achieve the same performance
level as the supervised learning.

| Info_Min | Strategy1 | Strategy2 |
|---|---|---|
| 51.9K | 40K | 31K |

In order to reach the performance of supervised learning, Strategy1 (40K words) and Strategy2 (31K words) required only about 80% and 60% respectively of the training data that Info_Min (51.9K) did.

FIG. 8 is a schematic block diagram of a named entity recognition active learning system 10 according to an embodiment of the invention. The named entity recognition active learning system 10 includes a memory 12 for receiving and storing a data set 14 input through an in/out port 16 from a scanner, the Internet or some other network or some other external means. The memory can also receive the data set directly from a user interface 18. The system 10 uses a processor 20 including a criteria module 22, to learn named entities in a received data set. The various components are all interconnected in this embodiment in a bus manner. The system could readily be embodied in a desk-top or lap-top computer, loaded with appropriate software.

The described embodiments relate to active learning in a complex NLP task, named entity recognition. A multi-criteria-based approach is used to select examples based on their informativeness, representativeness and diversity, which may be incorporated together. Experiments using example embodiments show that, in both MUC-6 and GENIA, combining the three criteria in a selection strategy outperforms a single criterion (informativeness) approach. The labelling cost can be significantly reduced compared with supervised learning.

Compared with previous approaches, the corresponding measurements/computations described in the example embodiments are general purpose, which can be adapted for use on other word sequence problems, such as POS tagging, text chunking and parsing. The multi-criteria strategies of the example embodiments can also be used for other machine learning approaches than SVM, such as boosting.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method of conducting named entity recognition, the method comprising
selecting one or more examples for human labelling, each example comprising a word sequence containing a named entity and its context; and
retraining a model for the named entity recognition based on the labelled examples as training data.

2. The method as claimed in claim 1, wherein the selecting is based on one or more criteria of a group consisting of an informativeness criterion, a representativeness criterion, and a diversity criterion.

3. The method as claimed in claim 2, wherein the selecting further comprises applying a strategy comprising two or more of the criteria in a selected sequence.

4. The method as claimed in claim 3, wherein the strategy comprises combining two or more of the criteria into a single criteria.

5. A method of conducting a word sequence processing task, the method comprising
selecting one or more examples for human labelling based on an informativeness criterion, a representativeness criterion, and a diversity criterion, and
retraining a model for the named entity recognition based on the labelled examples as training data.

6. The method as claimed in claim 5, wherein the word sequence processing task comprises one or more of a group consisting of POS tagging, text chunking and parsing.

7. A system for conducting named entity recognition, the system comprising
a selector for selecting one or more examples for human labelling, each example comprising a word sequence containing a named entity and its context; and
a processor for retraining a model for the named entity recognition based on the labelled examples as training data.

8. A system for conducting a word sequence processing task, the system comprising
a selector for selecting one or more examples for human labelling based on an informativeness criterion, a representativeness criterion, and a diversity criterion, and
a processor for retraining a model for the named entity recognition based on the labelled examples as training data.

9. A data storage medium having stored thereon computer code means for instructing a computer to execute a method of conducting named entity recognition, the method comprising
selecting one or more examples for human labelling, each example comprising a word sequence containing a named entity and its context; and
retraining a model for the named entity recognition based on the labelled examples as training data.

10. A data storage medium having stored thereon computer code means for instructing a computer to execute a method of conducting a word sequence processing task, the method comprising
selecting one or more examples for human labelling based on an informativeness criterion, a representativeness criterion, and a diversity criterion, and
retraining a model for the named entity recognition based on the labelled examples as training data.
